(19) United States
(12) Patent Application Publication
(10) Pub. No.: US 2026/0125586 A1
(43) Pub. Date: May 7, 2026

(54) POLYURETHANE HOT MELT ADHESIVE BASED ON RECYCLABLE RAW MATERIALS AND PREPARATION METHOD THEREFOR

(71) Applicant: SUZHOU SHIHUA NEW MATERIAL TECHNOLOGY CO., LTD., Suzhou (CN)

(72) Inventors: Shuai Chen, Suzhou (CN); Bin Ren, Suzhou (CN); Botong Gu, Suzhou (CN); Jianrong Ji, Suzhou (CN)

(21) Appl. No.: 19/437,176

(22) Filed: Dec. 30, 2025

Related U.S. Application Data
(63) Continuation-in-part of application No. PCT/CN2023/138845, filed on Dec. 14, 2023.

(30) Foreign Application Priority Data
Nov. 3, 2023 (CN) 202311454309.3

(51) Int. Cl. C09J 175/06; C09J 11/06

(52) U.S. Cl. CPC C09J 175/06; C09J 11/06; C09J 2467/00; C09J 2475/00

(57) ABSTRACT

Provided is a recyclable raw material-based polyurethane hot melt adhesive. Raw materials for preparing the polyurethane hot melt adhesive include: a recycled PET-based polyester polyol, a recyclable polylactic acid-based polyol, a petroleum-based polyol and/or tackifying resin, a secondary amine group-containing silane coupling agent, and an isocyanate. The content of the recycled PET-based polyester polyol is 50-70% by weight relative to the total weight of the polyurethane hot melt adhesive, and the amount of the isocyanate added is such that the molar ratio of NCO/OH is within a range of 2 to 5. A polyurethane hot melt adhesive is obtained by synthesizing through bulk polymerization with maximal use of the recycled material-based polyol, and the content of the recycled component in the hot melt adhesive may reach more than 20%.

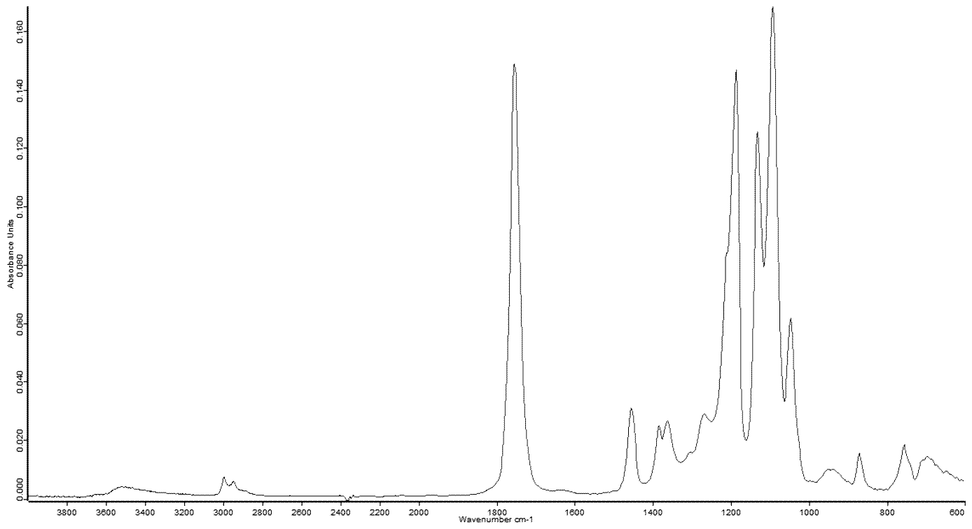

### CROSS-REFERENCE TO RELATED APPLICATIONS

The present application is a continuation-in-part application of PCT application No. PCT/CN2023/138845 filed on Dec. 14, 2023, which claims the benefit of Chinese Patent Application No. 202311454309.3 filed on Nov. 3, 2023. The contents of all of the aforementioned applications are incorporated by reference herein in their entirety.

### FIELD

The present disclosure relates to polyurethane adhesives, and in particular to a recyclable raw material-based polyurethane hot melt adhesive and a method of preparing the same.

### BACKGROUND

In recent years, with the rising awareness of sustainable development, cost saving, and environmental health, there has been a growing interest in utilizing circular resources such as biomass, renewable, and recyclable resources for production of polymer materials. Studies have shown that circular resource-based polymer synthesis corresponds to a 7%-15% reduction in use of petroleum and natural gas. Therefore, there is an urgent need for extensive innovative researches on circular resource-based polymer synthesis so as to gradually reduce dependence on petroleum-based materials for positive contribution to environmental protection. Meanwhile, international companies have attached greater importance to carbon footprint reduction in the use of chemical products, which indicates that the materials derived from biomass and recyclable resources have a significant market potential.

The sustainable raw materials eligible for ISCC (International Sustainability & Carbon Certification) certification mainly cover four types as follows: (i) biomass-based raw materials, including products derived from agricultural feedstocks (e.g., corn); (ii) recyclable raw materials, originated from non-biomass wastes or residues (e.g., plastic waste); (iii) biomass-recyclable raw materials, originated from biomass wastes or residues (e.g., renewable waste edible oils); (iv) renewable energy-based raw materials, including non-biomass raw materials produced using renewable energy.

In the field of adhesive technology, polyurethane adhesives are one of the most scalable research directions and also one of the most extensively used types among solvent-free adhesives, which can form an excellent bonding strength with porous surfaces such as ceramics and smooth surfaces such as metal foils, glass, and polymer films, thus having extensive applications. Researches on the synthesis and applications of biobased polyurethane adhesives based on renewable resources such as modified vegetable oils, polysaccharides, and lignin derivatives have been emerging continuously, which exhibit a performance comparable to or even superior to that of commercial petroleum-based adhesives.

For example, Patent CN202210712666.4 discloses a method of preparing a degradable biobased polyurethane adhesive, which is originated from renewable biomass raw materials including tannins, polylactic acid, and 2,5-furandimethanol. The specific synthesis process comprises: firstly, synthesizing tannin-modified polyol and polylactic acid-2,5-furandimethanol ester polyol sequentially; then, polymerizing the synthesized tannin-modified polyol and polylactic acid-2,5-furandimethanol ester polyol with isocyanate in a xylene solvent; finally, removing the solvent and impurities by vacuum distilling, thereby obtaining the biobased polyurethane. Composting tests on the prepared polyurethane show that it can be completely degraded within 360 days without residual mass. A key point of the patent lies in the synthesis of a degradable biobased polyurethane adhesive. It is noted that there are differences in performance and purity between the raw material monomers extracted from biomass and those extracted from petroleum-based wastes, which in turn lead to differences in the performance of the synthetic products based on these extracted monomers. In addition, the polymerization reaction described in the patent is conducted in a solvent medium, which is highly toxic xylene; compared with conventional bulk polymerization methods of preparing polyurethane hot melt adhesives, the solvent-based synthesis method is not advantageous.

Therefore, it is desirable to develop a polyurethane hot melt adhesive with a sustainable raw material eligible for ISCC certification using a bulk polymerization method.

### SUMMARY

The present disclosure provides a concept of preparing a recyclable raw material-based polyurethane hot melt adhesive by bulk polymerization, where the recyclable raw material is originated from non-biomass waste or residues and the synthesized polyurethane hot melt adhesive has a recyclable content of more than 20%. In addition, performance comparisons between the recycled component-containing polyurethane hot melt adhesives synthesized according to the present disclosure and those petroleum-based counterparts on the market indicate that the polyurethane hot melt adhesives synthesized with recycled raw materials can replace typical petroleum-based hot melt adhesive products.

By selecting a recycled upstream raw material, preparing a target polyol, adjusting a final formulation, and modifying specifically to a product, the recyclable raw material-based polyurethane hot melt adhesive according to the present disclosure has an excellent bonding effect with respect to for example a metal material or a plastic substrate such as polyimide, as well as an improved hydrothermal aging resistance performance.

To achieve the effects noted supra, the present disclosure offers a technical solution below:

A recyclable raw material-based polyurethane hot melt adhesive comprises, in parts by weight:
50-70 parts of recycled PET-based polyester polyol;
10-30 parts of recyclable polylactic acid-based polyol,
0-15 parts of petroleum-based polyol, 0-10 parts of tackifying resin,
2-15 parts of secondary amine-containing silane coupling agent,
and 10-30 parts of isocyanate;
wherein the parts by weight of the petroleum-based polyol and the tackifying resin are not both zero;
total parts by weight of the polyurethane hot melt adhesive is 100 parts;
molecular weight of the recycled PET-based polyester polyol is 2000-3500;
and an amount of the isocyanate added is controlled such that NCO/OH molar ratio R falls within the range of 2-5.

The recycled PET-based polyester polyol accounts for 50 wt % to 70 wt % of the total weight of the polyurethane hot melt adhesive. The hot melt adhesive prepared according to the present disclosure uses a large proportion of recycled PET-based polyester polyol, offering an advantage that since the molecular structure of the recycled PET-based polyester polyol includes numerous aromatic ring structures, the hot melt adhesive exhibits excellent adhesion to metal substrates and high-polarity polyimide materials. Due to the rigid structure of aromatic rings, the numerous aromatic ring structures in the hot melt adhesive can improve its heat resistance performance; compared with an aliphatic polyurethane, the aromatic polyurethane also exhibits a better water resistance performance. Tests indicate that in a case that the weight proportion of the recycled PET-based polyester polyol is 50% or higher, the adhesive strength of the hot melt adhesive to anodized aluminum or stainless steel is significantly increased, and its double 85 aging resistance is also notably improved. However, use of the recycled PET-based polyester polyol in high proportion leads to a problem: compared with aliphatic crystalline polyols with the same molecular weight and hydroxyl value, the polyurethane hot melt adhesive synthesized with the recycled PET-based polyester polyol has a higher viscosity under a same NCO/OH ratio. In the electronics industry, however, the viscosity of polyurethane hot melt adhesive is mostly required to be low to achieve narrow adhesive line application and smooth dispensing. Therefore, when designing a formulation of the polyurethane hot melt adhesive with a large amount of recycled PET-based polyester polyol, the NCO/OH ratio needs to be increased to reduce viscosity of the polyurethane hot melt adhesive.

The molecular weight of the recycled PET-based polyester polyol is 2000-3500. In the formulation of the present disclosure, a high proportion of recycled PET-based polyester polyol is used; if a small-molecular-weight polyol of this type is selected, it tends to form a low-rigidity polyurethane foam material with notable foaming after reacting with isocyanate, which do not have the performance features of the polyurethane hot melt adhesive. Thus, the recycled PET-based polyester polyol with a molecular weight of 2000-3500 with a corresponding hydroxyl value of 27-62 mgKOH/g is preferably selected. Available commercial brands include: HOOPOL F-39037 and HOOPOL F-39032 from Hoocker Chemical (Spain), with a recyclable content of 38%; and 51041-2000 from Changxing Chemical, with a hydroxyl value of 50-65 mgKOH/g and a recyclable content of 40%.

The recyclable polylactic acid-based polyol is in-house prepared with a hydroxyl value of 20-140 mgKOH/g, a preparation process of which comprises steps of:
1) adding the recycled polylactic acid into a reactor, followed by heating to 160° C.-190° C. to obtain molten polylactic acid.
2) evacuating at −0.1 MPa for 30 minutes; followed by vacuum breaking and introducing an inert gas into the reactor to replace the air inside for 20 minutes.
3) adding small-molecular diol and catalyst sequentially into the reactor, followed by stirring for 5-15 minutes and repeating inert gas replacement for 20 minutes.
4) reacting under inert gas protection at controlled temperature of 180° C.-190° C. for 4-10 hours.
5) evacuating at controlled temperature of 180° C.±5° C. at −0.1 MPa for 30 minutes to remove residual unreacted small-molecular diol.
6) cooling to 120° C.±5° C. and discharging the recyclable polylactic acid-based polyol.

The recyclable polylactic acid is Luminy® rPLA, a commercial product from Total Corbion PLA, with a recyclable content of 20%. The small-molecular diol is a monomeric diol with a single chemical structure, not a dimer or an oligomer whose main chain segment has a repeat number greater than 2; the small-molecular diol comprises one or more of diethylene glycol, butanediol, ethylene glycol, and propylene glycol; preferably, the small-molecular diol is butanediol and/or diethylene glycol. The catalyst is a combination of one selected from tetrabutyl titanate, tetraisopropyl titanate, and a mixture of antimony trioxide and zinc acetate, and one selected from zinc lactate, stannous lactate, zinc oxide, and stannous oxide. Preferably, the hydroxyl value of the synthesized recyclable polylactic acid-based polyol is 56-62 mgKOH/g. The recyclable polylactic acid-based polyol in the formulation functions to improve wettability of the hot melt adhesive and neutralize the fast tack-free property of the recycled PET-based polyester polyol that accounts for a high proportion in the formulation. The maximum combined use of the recyclable polylactic acid-based polyol and the recycled PET-based polyester polyol can increase the content of recyclable components of the hot melt adhesive.

The petroleum-based polyol can be a crystalline polyester polyol, prepared by condensation reaction from one or more of succinic acid, adipic acid, sebacic acid, and dodecanedioic acid, and one or more of ethylene glycol, butanediol, and hexanediol, typical commercial brands of which include Dynacoll 7360, Dynacoll 7361, and Dynacoll 7330 from EVONIK; and HOOPOL F-911 and HOOPOL F-932 from Hoocker Chemical (Spain). The petroleum-based polyol can also be a liquid polyester polyol, prepared by condensation reaction from one or more of succinic acid, adipic acid, sebacic acid, maleic acid, fumaric acid, and cyclohexanecarboxylic acid, and one or more of ethylene glycol, butanediol, hexanediol, diethylene glycol, neopentyl glycol, and 1,5-pentanediol, typical commercial brands of which include Dynacoll 7250, Dynacoll 7230, and Dynacoll 7210 from EVONIK. The petroleum-based polyol can further be a polyether polyol, including polyethylene glycol (PEG), polypropylene oxide diol, and polytetramethylene ether glycol (PTMEG), typical commercial brands of which include PEG-1000 from Kunshan Guodu Chemical; VORANOL 2110 TB and VORANOL 2120 from Dow; and PTMEG-1000 from Hyosung Chemical.

The tackifying resin can be an acrylic resin, typical commercial brands of which include MB-2595 and MB-2592 from Mitsubishi Acrylic Resins (Japan); the tackifying resin can also be a petroleum resin, typical commercial brands of which include W-85 and W-100 from Cray Valley (France); or the tackifying resin can be APAO (amorphous α-olefin copolymer), typical commercial brands of which include VESTOPLAST 508, VESTOPLAST 708, and VESTOPLAST 750 from EVONIK.

The amount of isocyanate added is such that the NCO/OH molar ratio, denoted as (R), is in the range of 2-5. Generally, the higher the value of R, the more free isocyanate in the system, and the lower the viscosity of the generated polyurethane prepolymer. The isocyanate is an aromatic diisocyanate, including but not limited to one or more of 4,4′-diphenylmethane diisocyanate, 2,4′-diphenylmethane diisocyanate, 2,2′-diphenylmethane diisocyanate, and carbodiimide-modified diphenylmethane diisocyanate.

The secondary amino group-containing silane coupling agent comprises only a single secondary amino group, including but not limited to one or more of N-n-butyl-3-aminopropyltrimethoxysilane, bis(trimethoxysilylpropyl)amine, bis-[3-(triethoxysilyl)-propyl]-amine, and N-ethyl-3-trimethoxysilyl-2-methylpropylamine, typical commercial brands of which include Dynasylan 1189 and Dynasylan 1124 from Evonik. The polyurethane hot melt adhesive is chemically modified using the secondary amino group-containing silane coupling agent; the secondary amino groups react with the excess NCO groups in the hot melt adhesive, thereby grafting onto the main chain of the polyurethane prepolymer. The secondary amino group-containing silane coupling agent, which is free of high-reactivity primary amino groups, only comprises one single secondary amino group, resulting in a mild reaction process without causing a sudden viscosity increase or local gelation. In summary, due to use of the secondary amino group-containing silane coupling agent, on one hand, the graft modification with the secondary amino group can consume the reactive NCO groups in the chemical chain of the polyurethane prepolymer without significantly increasing the viscosity of the hot melt adhesive, thereby reducing the foaming problem in the subsequent curing process of the hot melt adhesive; on the other hand, the silane grafted onto the polyurethane prepolymer undergoes a crosslinking reaction with water; the Si—C bonds and Si—O bonds in the silane itself are non-hydrolysable, have high bond energy, and may withstand high temperature. Additionally, the aromatic rings in the recycled PET-based polyester polyol exert a certain steric hindrance effect on hydrolysis of ester bonds, so that the aromatic ring structure is more resistant to high temperature than the aliphatic chain structure. In conclusion, the modification with the secondary amino group-containing silane coupling agent synergizes with the numerous PET terephthalic anhydride chemical bond structures in the hot melt adhesive, which can significantly improve the hydrothermal aging resistance of the polyurethane hot melt adhesive.

The polyurethane hot melt adhesive further comprises 0.07-3.5 parts of weight of additive, the additive including a first additive and/or a second additive. The first additive is selected from one or more of a defoamer, an antioxidant, and a fluorescent agent; and the second additive is selected from one or more of an amine-based catalyst, a water scavenger, a defoamer, an antioxidant, and a fluorescent agent. The first additive, the additive being selected from one or more of a defoamer, a fluorescent agent, a water scavenger, an antioxidant, and an amine-based catalyst. The defoamer preferably selects an acrylate-based defoamer, typical commercial brands of which include BYK-A535, BYK-088, and BYK-1790 from BYK-Chemie, with BYK-A535 being preferrable. The antioxidant functions to reduce a yellowing phenomenon of the polyurethane hot melt adhesive and slow down its thermal aging; optional antioxidants include but are not limited to Antioxidant 1010, Antioxidant 264, Antioxidant 168, and Antioxidant 1076, with Antioxidant 1010 being preferrable. The fluorescent agent functions to enhance a resolution characteristic of the hot melt adhesive, typical commercial brands of which include Ciba® UVITEX OB and BASF CBS-X from BASF, with UVITEX OB being preferrable. The amine-based catalyst functions to promote the curing reaction between the polyurethane hot melt adhesive and moisture; the optional amine-based catalysts include but are not limited to bis(2-morpholinoethyl) ether DMDEE, bis(2-dimethylaminoethyl) ether, N,N-dimethylcyclohexylamine, triethylenediamine, and N-ethylmorpholine, with bis(2-morpholinoethyl) ether (DMDEE) being preferrable. The water scavenger mainly functions to consume trace moisture in the hot melt adhesive to improve its stability; optional water scavengers include but are not limited to p-toluenesulfonyl isocyanate (PTSI), 3-isocyanatopropyltrimethoxysilane, and 3-isocyanatopropyltriethoxysilane, with p-toluenesulfonyl isocyanate PTSI being preferrable.

A method of preparing a recyclable raw material-based polyurethane hot melt adhesive, comprising steps of:
1) preparing a molten polyol mixture using the following raw materials:
   a) at least one type of recycled PET-based polyester polyol;
   b) at least one type of recyclable polylactic acid-based polyol;
   c) petroleum-based polyol or tackifying resin
2) adding isocyanate to react with the polyol mixture for polymerization to obtain a polyurethane prepolymer, where a molar ratio of NCO groups in the isocyanate to OH groups in the polyol mixture being 2-5;
3) adding a secondary amino group-containing silane coupling agent, and grafting it onto a main chain of the polyurethane prepolymer, thereby obtaining the recyclable raw material-based polyurethane hot melt adhesive.

Preferably, a first additive is added between step 1) and step 2); or/and a second additive is added between step 2) and step 3).

Preferably, a process of preparing the recyclable raw material-based polyurethane hot melt adhesive comprises steps of:
1) adding the recycled PET-based polyester polyol, the recyclable polylactic acid-based polyol, the petroleum-based polyol, and/or the tackifying resin together into a reactor, followed by stirring and melting at 120-160° C. until a homogeneous molten state is achieved;
2) then, adding one or more of the fluorescent agent, the defoamer, and the antioxidant, followed by stirring for homogeneity;
3) evacuating and dehydrating at a vacuum degree of −0.1 MPa for 1-2 hours;
4) cooling the reaction system to 80° C.±2° C., and adding isocyanate thereto, where the reaction is conducted at 80-100° C. for 30 minutes with no external heating applied; then, externally heating to control the temperature at approximately 110° C. while evacuating to undergo a defoaming reaction at a vacuum degree of −0.1 MPa for 30 minutes;
5) adding the water scavenger and the catalyst sequentially to react at 110° C. for 10 minutes to prepare a polyurethane prepolymer kept in a molten state;
6) cooling the reaction system to 90° C., followed by adding the secondary amino group-containing silane coupling agent thereto and reacting at a controlled temperature of 90° C.±5° C. for 20 minutes; then evacuating for a defoaming reaction at a vacuum degree of −0.1 MPa for 10 minutes;
7) breaking the vacuum and discharging a resultant polyurethane hot melt adhesive under the protection of an inert gas.

### BENEFITS OF THE PRESENT DISCLOSURE

The present disclosure obtains a polyurethane hot melt adhesive by synthesizing through bulk polymerization with maximal use of the recycled material-based polyol, and the content of the recycled component in the hot melt adhesive may reach more than 20%.

The recycled material-based polyurethane hot melt adhesive of the present disclosure is mainly applicable to the electronics industry, with its hydrothermal aging resistance and adhesive properties to metal substrates as well as plastic substrates being superior to those of the petroleum-based hot melt adhesives available on the market.

Owing to extensive use of the recycled PET-based polyester polyol, the viscosity of the hot melt adhesive is increased; by increasing the amount of isocyanate added, the viscosity is reduced; then, the secondary amino group-containing silane coupling agent is used to consume part of the excess NCO groups introduced by the isocyanate; finally, the hot melt adhesive exhibits no obvious foaming after curing, thereby achieving a balance between viscosity control and suppressing post-curing foaming.

### BRIEF DESCRIPTION OF THE DRAWINGS

Hereinafter, the present disclosure will be further explained through embodiments with reference to the accompanying drawings.

The sole FIGURE is an infrared spectrum of recyclable polylactic acid-based polyol PLA-1.

### DETAILED DESCRIPTION OF EMBODIMENTS

In the context of the present disclosure, the term “x-y” shall be understood as denote a range inclusive of the boundaries x and y. For example, the range “molecular weight of 2000-3500” particularly includes the values 2000 and 3000.

Hereinafter, the present disclosure will be described through embodiments. The embodiments are given only as examples and shall not be interpreted as limiting the scope of the present disclosure.

### Preparation of Recyclable Polylactic Acid-Based Polyol

The small-molecular diol used in preparation step 3) is a monomeric diol with a single chemical structure, not a dimer or an oligomer whose main chain segment has a repeat number greater than 2.

Two examples of recycled polylactic acid-based polyols were prepared, denoted as follows: PLA-1 with a recycled content of 14% and a hydroxyl value of 59 mgKOH/g, and PLA-2 with a recycled content of 13.3% and a hydroxyl value of 59.16 mgKOH/g.

### Preparation of PLA-1

1) 100 parts by weight of recyclable polylactic acid Luminy® rPLA were added into a reactor, followed by heating to 160° C.-190° C. to obtain molten polylactic acid;
2) the reactor was evacuated to a vacuum degree of −0.1 MPa for 30 minutes, followed by breaking the vacuum and introducing nitrogen gas into the reactor to replace air therein for 20 minutes;
3) 20 parts by weight of small-molecular butanediol, 0.2 parts by weight of tetrabutyl titanate, and 0.3 parts by weight of stannous lactate were added into the reactor, followed by stirring for 10 minutes and then repeating nitrogen replacement for 20 minutes;
4) the temperature was controlled at 180° C.-190° C., and the reaction proceeded for 4-10 hours under nitrogen protection;
5) the reactor was evaluated to a vacuum degree of −0.1 MPa at 180° C. for 30 minutes to remove residual unreacted small-molecular diol;
6) the reaction system was cooled to 120° C. to discharge the recyclable polylactic acid-based polyol, denoted as PLA-1, a recyclable content of which is approximately 14% based on mass conversion. The sole FIGURE shows the infrared spectrum of recyclable polylactic acid-based polyol PLA-1.

### Preparation of PLA-2

1) 100 parts by weight of recyclable polylactic acid Luminy® rPLA were added into a reactor, followed by heating to 160-190° C. to obtain molten polylactic acid;
2) the reactor was evacuated to a vacuum degree of −0.1 MPa for 30 minutes, followed by breaking the vacuum and introducing nitrogen gas into the reactor to replace air therein for 20 minutes;
3) 23.55 parts by weight of small-molecular diethylene glycol, 0.2 parts by weight of tetraisopropyl titanate, and 0.3 parts by weight of zinc lactate were added sequentially into the reactor, followed by stirring for 10 minutes and then repeating nitrogen replacement for 20 minutes;
4) the temperature was controlled at 180° C.-190° C., and the reaction was conducted for 4-10 hours under nitrogen protection;
5) the reactor was evacuated to a vacuum degree of −0.1 MPa at 180° C. for 30 minutes to remove residual unreacted small-molecular diol;
6) the reaction system was cooled to 120° C., and the recyclable polylactic acid-based polyol product was discharged, denoted as PLA-2, with a recyclable content of approximately 13.3% based on mass conversion.

### II. Synthesis of Recyclable Raw Material-Based Polyurethane Hot Melt Adhesive

### Example 1

1) 50 parts by weight of recycled PET-based polyester polyol F-39037, 10 parts by weight of recyclable polylactic acid-based polyol PLA-1, and 15.15 parts by weight of petroleum-based polyol Dynacoll 7360 were added together into a reactor, followed by stirring and melting at 120° C. until a homogeneous molten state was achieved;
2) 0.1 parts by weight of defoamer BYK-A535 and 0.05 parts by weight of fluorescent agent UVITEX OB were then added and stirred for homogeneity;
3) evacuation was initiated, followed by dehydrating for 1.5 hours at a vacuum degree of −0.1 MPa;
4) the reaction system was cooled to 80° C., followed by adding 20.5 parts by weight of 4,4′-diphenylmethane diisocyanate; in a case of applying no external heating, the reaction proceeds for 30 minutes; and in a case of externally heating to approximately 110° C. while initiating evacuation, a defoaming reaction proceeds for 30 minutes at a vacuum degree of −0.1 MPa;
5) 0.1 parts by weight of catalyst DMDEE and 0.1 parts by weight of water scavenger PTSI were sequentially added to react at 110° C. for 10 minutes to prepare a polyurethane prepolymer, while maintaining the resultant polyurethane prepolymer in a molten state;
6) the reaction system was cooled to 90° C., and 4 parts by weight of secondary amine-containing silane coupling agent Dynasylan 1189 were added to react at controlled 90° C. for 20 minutes, followed by initiating evacuation to perform the defoaming reaction for 10 minutes at a vacuum degree of −0.1 MPa;
7) the vacuum was broken, and the resultant recyclable raw material-based polyurethane hot melt adhesive was discharged under nitrogen protection.

### Example 2

1) 55 parts by weight of recycled PET-based polyester polyol F-39037, 10 parts by weight of recyclable polylactic acid-based polyol PLA-2, and 6.5 parts by weight of petroleum-based polyol Dynacoll 7230 were added together into a reactor, followed by stirring and melting at 120° C. until a homogeneous molten state was achieved;
2) 0.1 parts by weight of antioxidant 1010 and 0.05 parts by weight of fluorescent agent UVITEX OB were then added and stirred for homogeneity;
3) evacuation was initiated, followed by dehydrating for 1.5 hours at a vacuum degree of −0.1 MPa;
4) the reaction system was cooled to 80° C., and 22.15 parts by weight of 4,4′-diphenylmethane diisocyanate were added, where in a case of applying no external heating, the reaction proceeds for 30 minutes; and in a case of externally heating to approximately 110° C. while initiating evacuation, a defoaming reaction proceeds for 30 minutes at a vacuum degree of −0.1 MPa;
5) 0.1 parts by weight of catalyst DMDEE and 0.1 parts by weight of water scavenger PTSI were sequentially added to react at 110° C. for 10 minutes to prepare a polyurethane prepolymer, while maintaining the resultant polyurethane prepolymer in a molten state;
6) the reaction system was cooled to 95° C., and 6 parts by weight of secondary amine-containing silane coupling agent Dynasylan 1124 were added to react at controlled 95° C. for 20 minutes, followed by initiating evacuation to perform a defoaming reaction for 10 minutes at a vacuum degree of −0.1 MPa;
7) the vacuum was broken, and the resultant recyclable raw material-based polyurethane hot melt adhesive was discharged under nitrogen protection.

### Example 3

1) 30 parts by weight of recycled PET-based polyester polyol F-39037, 20 parts by weight of recycled PET-based polyester polyol 51041-2000, 10 parts by weight of recyclable polylactic acid-based polyol PLA-1, 9 parts by weight of petroleum-based polyol VORANOL 2120, and 5.15 parts by weight of acrylic tackifying resin MB-2595 were added together into a reactor, followed by stirring and melting at 130° C. until a homogeneous molten state was achieved;
2) 0.1 parts by weight of defoamer BYK-088 and 0.05 parts by weight of fluorescent agent UVITEX OB were then added and stirred for homogeneity;
3) evacuation was initiated, followed by dehydrating for 1.5 hours at a vacuum degree of −0.1 MPa;
4) the reaction system was cooled to 78° C. and 20.5 parts by weight of 4,4′-diphenylmethane diisocyanate were added, where in a case of applying no external heating, the reaction proceeds for 30 minutes; and in a case of externally heating to approximately 110° C. while initiating evacuation, a defoaming reaction proceeds for 30 minutes at a vacuum degree of −0.1 MPa;
5) 0.1 parts by weight of catalyst DMDEE and 0.1 parts by weight of water scavenger PTSI were sequentially added to react at 110° C. for 10 minutes to prepare a polyurethane prepolymer, while maintaining the resultant polyurethane prepolymer in a molten state;
6) the reaction system was cooled to 90° C., 5 parts by weight of secondary amine-containing silane coupling agent Dynasylan 1189 were added to react at controlled 90° C. for 20 minutes, followed by initiating evacuation to perform a defoaming reaction for 10 minutes at a vacuum degree of −0.1 MPa;
7) the vacuum was broken, and the resultant recyclable raw material-based polyurethane hot melt adhesive was discharged under nitrogen protection.

### Example 4

1) 40 parts by weight of recycled PET-based polyester polyol F-39032, 10 parts by weight of recycled PET-based polyester polyol 51041-2000, 10 parts by weight of recyclable polylactic acid-based polyol PLA-2, 10 parts by weight of petroleum-based polyol F-932, and 5 parts by weight of tackifying resin APAO Resin 508 were added together into a reactor, followed by stirring and melting at 140° C. until a homogeneous molten state was achieved;
2) 0.1 parts by weight of antioxidant 1010 were then added and stirred for homogeneity;
3) evacuation was initiated, followed by dehydrating for 1.5 hours at a vacuum degree of −0.1 MPa;
4) the reaction system was cooled to 82° C., and 20.7 parts of 4,4′-diphenylmethane diisocyanate were added to react for 30 minutes, where in a case of applying no external heating, the reaction proceeds for 30 minutes; and in a case of externally heating to approximately 110° C. while initiating evacuation, a defoaming reaction proceeds for 30 minutes at a vacuum degree of −0.1 MPa.
5) 0.1 part of catalyst DMDEE and 0.1 part of water scavenger 3-isocyanatopropyltrimethoxysilane were sequentially added to react at 110° C. for 10 minutes to prepare a polyurethane prepolymer, while maintaining the resultant polyurethane prepolymer in a molten state;
6) the reaction system was cooled to 95° C., and 4 parts of secondary amine-containing silane coupling agent Dynasylan 1124 were added to react at controlled 95° C. for 20 minutes, followed by initiating evacuation to perform a defoaming reaction for 10 minutes at a vacuum degree of −0.1 MPa;
7) the vacuum was broken, and the resultant recyclable raw material-based polyurethane hot melt adhesive was discharged under nitrogen protection.

### Example 5

1) 70 parts of recycled PET-based polyester polyol F-39032, 10 parts of recyclable polylactic acid (PLA)-based polyol PLA-2, and 4.7 parts of tackifying resin Cray Valley W-85 were added together into a reactor, followed by stirring and melting at 140° C. until a homogeneous molten state was achieved;
2) 0.1 parts by weight of antioxidant 1010 were then added and stirred for homogeneity;
3) evacuation was initiated, followed by dehydrating for 1.5 hours at a vacuum degree of −0.1 MPa;
4) the reaction system was cooled to 82° C., 13 parts of 4,4′-diphenylmethane diisocyanate were added to react for 30 minutes, followed by externally heating to approximately 110° C. while initiating evacuation, and defoaming for 30 minutes at a vacuum degree of −0.1 MPa;
5) 0.1 part of catalyst DMDEE and 0.1 part of water scavenger 3-isocyanatopropyltrimethoxysilane were sequentially added to react at 110° C. for 10 minutes to prepare a polyurethane prepolymer, while maintaining the resultant polyurethane prepolymer in a molten state;
6) the reaction system was cooled to 95° C., 2 parts of secondary amine-containing silane coupling agent Dynasylan 1124 were added to react at controlled 95° C. for 20 minutes, followed by initiating evacuation to perform a defoaming reaction for 10 minutes at a vacuum degree of −0.1 MPa;
7) the vacuum was broken, and the resultant recyclable raw material-based polyurethane hot melt adhesive was discharged under nitrogen protection.

### Example 6

1) 50 parts of recycled PET-based polyester polyol F-39037, 19.7 parts of recyclable polylactic acid-based polyol PLA-1, and 2.15 parts of tackifying resin Cray Valley W-100 were added together into a reactor, followed by stirring and melting at 120° C. until a homogeneous molten state was achieved;
2) 0.1 parts of defoamer BYK-A535 and 0.05 part of fluorescent agent UVITEX OB were then added and stirred for homogeneity;
3) evacuation was initiated, followed by dehydrating for 1.5 hours at a vacuum degree of −0.1 MPa;
4) the reaction system was cooled to 80° C., 12.3 parts of 4,4′-diphenylmethane diisocyanate were added to react for 30 minutes, followed by externally heating to approximately 110° C. while initiating evacuation, and defoaming for 30 minutes at a vacuum degree of −0.1 MPa;
5) 0.1 part of catalyst DMDEE and 0.6 part of water scavenger PTSI were sequentially added to react at 110° C. for 10 minutes to prepare a polyurethane prepolymer, while maintaining the resultant polyurethane prepolymer in a molten state;
6) the reaction system was cooled to 95° C., 15 parts of secondary amine-containing silane coupling agent Dynasylan 1189 were added to react at controlled 90° C. for 20 minutes, followed by initiating evacuation to perform a defoaming reaction for 10 minutes at a vacuum degree of −0.1 MPa;
7) the vacuum was broken, and the resultant recyclable raw material-based polyurethane hot melt adhesive was discharged under nitrogen protection.

### Example 7

1) 50 parts of recycled PET-based polyester polyol F-39037, 30 parts of recyclable polylactic acid-based polyol PLA-1, and 2 parts of tackifying resin APAO Resin 508 were added together into a reactor, followed by stirring and melting at 120° C. until a homogeneous molten state was achieved;
2) 0.1 part of defoamer BYK-A535 and 0.1 part of fluorescent agent UVITEX OB were then added and stirred for homogeneity;
3) evacuation was initiated, followed by dehydrating for 1.5 hours at a vacuum degree of −0.1 MPa;
4) the reaction system was cooled to 80° C., 15.5 parts of 4,4′-diphenylmethane diisocyanate were added to react for 30 minutes, followed by externally heating to approximately 110° C. while initiating evacuation, and defoaming for 30 minutes at a vacuum degree of −0.1 MPa;
5) 0.1 part of catalyst DMDEE and 0.6 part of water scavenger PTSI were sequentially added to react at 110° C. for 10 minutes to prepare a polyurethane prepolymer, while maintaining the resultant polyurethane prepolymer in a molten state;
6) the reaction system was cooled to 95° C., 0.2 part of catalyst DMDEE and 0.1 part of water scavenger PTSI were added to react at controlled 90° C. for 20 minutes, followed by initiating evacuation to perform a defoaming reaction for 10 minutes at a vacuum degree of −0.1 MPa;
7) the vacuum was broken, and the resultant recyclable raw material-based polyurethane hot melt adhesive was discharged under nitrogen protection.

### Comparative Examples

The preparation methods of the comparative examples are the same as Example 1, while the other components and parts by weight are set forth in the following table:

| Comparative | Comparative |
|---|---|
| example 7 | example 8 |
| 50 parts of | 73 parts of |
| F-39037 | F-39032 |
| 10 parts of | 10 parts of |
| PLA-1 | PLA-2 |
| 15.15 parts of | 0 parts |
| Dynacoll7360 | |
| 0 | 1.7 parts of |
| | Cray Valley W-85 |
| 20.5 parts | 13 parts |
| 4 parts of | 2 parts of |
| 3-aminopropyl- | Dynasylan 1189 |
| trimethoxysilane | |
| Same as | Between Step 1) |
| example 1 | and Step 2): |
| | 0.1 part of |
| | antioxidant 1010; |
| | Between Step 2) |
| | and Step 3): |
| | 0.1 part of |
| | 3-isocyanatopropyl- |
| | trimethoxysilane |
| | and 0.1 part of |
| | DMDEE |

| Components and | Comparative | Comparative | | Comparative | | Comparative | Comparative | Comparative | Comparative |
|---|---|---|---|---|---|---|---|---|---|
| Parts by Weight | example 1 | example 2 | | example 3 | | example 4-1 | example 4-2 | example 5 | example 6 |
| Recyclable PET- | 30 parts of | 50 parts of | | 0 | parts | 50 parts of | 50 parts of | 50 parts of | 50 parts of |
| based Polyol | F-39037 | F-39037 | | | | F-39037 | F-39037 | F-39037 | F-39037 |
| | | | | | | | 10.5 parts of | | |
| | | | | | | | 51041-2000 | | |
| Recyclable | 30 parts of | 0 | parts | 60 parts of | | 10 parts of | 10 parts of | 10 parts of | 10 parts of |
| Polylactic Acid | PLA-1 | | | PLA-1 | | PLA-1 | PLA-1 | PLA-1 | PLA-1 |
| (PLA)-based Polyol | | | | | | | | | |
| Petroleum-based | 13.65 parts of | 12 parts of | | 15.15 parts | | 21.15 parts | 11.15 parts | 8.15 parts of | 15.15 parts of |
| Polyol | Dynacoll7360 | Dynacoll7250 | | of | | of VORANOL | of VORANOL | Dynacoll7360 | Dynacoll7360 |
| | | 15.15 parts of | | Dynacoll7360 | | 2120 | 2120 | | |
| | | Dynacoll7360 | | | | | | | |
| Tackifying Resin | 0 | 0 | | 0 | | 0 | 0 | 0 | 0 |
| 4,4′- | 22 parts | 18.5 | parts | 20.5 | parts | 14.5 parts | 14 parts | 27.5 parts | 20.5 parts |

| | | | | | | | |
|---|---|---|---|---|---|---|---|
| Diphenylmethane | | | | | | | |
| Diisocyanate | | | | | | | |
| Silane Coupling | 4 parts of | 4 parts of | 4 parts of | 4 parts of | 4 parts of | 4 parts of | 4 parts of N- |
| Agent | Dynasylan 1189 | Dynasylan 1189 | Dynasylan | Dynasylan | Dynasylan | Dynasylan | (2-N- |
| | | | 1189 | 1189 | 1189 | 1189 | benzylaminoethyl)- |
| | | | | | | | 3-aminopropyltrimeth- |
| | | | | | | | oxysilane |
| Additive | Same as | Same as | Same as | Same as | Same as | Same as | Same as |
| | example 1 | example 1 | example 1 | example 1 | example 1 | example 1 | example 1 |

In addition, a petroleum-based polyurethane hot melt electronic adhesive EH9650 with certain versatility currently available on the market is selected for comparison. The physical properties and performance test results of Examples 1-7. Comparative Examples 1-8 and EH9650 are as follows:

| | Example | | Example | | Example | | Example | | Example | | Example | | Example | | Comparative | | Comparative | |
|---|---|---|---|---|---|---|---|---|---|---|---|---|---|---|---|---|---|---|
| Test items | 1 | | 2 | | 3 | | 4 | | 5 | | 6 | | 7 | | Example 1 | | Example 2 | |
| Recycled | 20.4 | | 22.22 | | 20.8 | | 20.52 | | 27.92 | | 21.76 | | 23.2 | | 15.6 | | 19 | |
| content (%) of | | | | | | | | | | | | | | | | | | |
| the hot-melt | | | | | | | | | | | | | | | | | | |
| adhesive | | | | | | | | | | | | | | | | | | |
| R | 3.53 | | 4.07 | | 2.92 | | 3.43 | | 2.11 | | 2.03 | | 2.09 | | 3.15 | | 3.67 | |
| Viscosity/ | 6012 | cp | 5607 | cp | 4958 | cp | 5545 | cp | 9400 | cp | 7825 | cp | 6157 | cp | 4779 | cp | 6567 | cp |
| 100° C. | | | | | | | | | | | | | | | | | | |
| Open | 6 | min | 7.5 | min | 8 | min | 5 | min | 2.5 | min | 4 | min | 6 | min | 9.5 | min | 6 | min |
| time@25° C. | | | | | | | | | | | | | | | | | | |
| Cured state | Not | | Not | | Not | | Not | | Not | | Not | | Not | | Not | | Not | |
| of glue line | foaming | | foaming | | foaming | | foaming | | foaming | | foaming | | foaming | | foaming | | foaming | |
| PC-PC lap | 9.5 | MPa | 8.8 | MPa | 10.5 | MPa | 10.6 | MPa | 7.9 | MPa | 7.4 | MPa | 8.4 | MPa | 7.2 | MPa | 8.9 | MPa |
| shear | | | | | | | | | | | | | | | | | | |
| DT4-A1An lap | 6.7 | MPa | 7.5 | MPa | 5.7 | MPa | 6.1 | MPa | 5.6 | MPa | 7.9 | MPa | 4.8 | MPa | 3.0 | MPa | 6.8 | MPa |
| shear | | | | | | | | | | | | | | | | | | |
| PI-PI 180° peel | 53.6 | N/in | 66.1 | N/in | 47.3 | N/in | 55.5 | N/in | 44.8 | N/in | 42.8 | N/in | 49.2 | N/in | 27.3 | N/in | 48.9 | N/in |

| strength | | | | | | | | | |
|---|---|---|---|---|---|---|---|---|---|
| Strength | 55.7% | 49.3% | 63.6% | 65.0% | 60.4% | 42.5% | 67.5% | 69.5% | 61.4% |
| attenuation rate | | | | | | | | | |
| after 7-day | | | | | | | | | |
| double 85 | | | | | | | | | |
| aging | | | | | | | | | |

| | Comparative | | Comparative | | Comparative | | Comparative | | Comparative | | Comparative | | Comparative | | | |
|---|---|---|---|---|---|---|---|---|---|---|---|---|---|---|---|---|
| Test items | Example 3 | | Example 4-1 | | Example 4-2 | | Example 5 | | Example 6 | | Example 7 | | Example 8 | | EH9650 | |
| Recycled | 8.4 | | 20.4 | | 24.6 | | 20.4 | | 20.4 | | 20.4 | | 29.06 | | / | |
| content (%) of | | | | | | | | | | | | | | | | |
| the hot-melt | | | | | | | | | | | | | | | | |
| adhesive | | | | | | | | | | | | | | | | |
| R | 2.29 | | 1.95 | | 1.87 | | 5.16 | | 3.53 | | 3.53 | | 2.04 | | / | |
| Viscosity/ | 3560 | cp | 23740 | cp | 19650 | cp | 2277 | cp | 8668 | cp | 9325 cp | | 13770 | cp | 4817 | cp |
| 100° C. | | | | | | | | | | | with gel | | | | | |
| | | | | | | | | | | | particles | | | | | |
| Open | 18 | min | 3 | min | 3.5 | min | 7.5 | min | 5 | min | 5 | min | 1.5 | min | 5.5 | min |
| time@25° C. | | | | | | | | | | | | | | | | |
| Cured state | Not | | Not | | Not | | Severe | | Not | | Not | | Not | | Not | |
| of glue line | foaming | | foaming | | foaming | | foaming | | foaming | | foaming | | foaming | | foaming | |
| PC-PC lap | 6.7 | MPa | 7.6 | MPa | 6.2 | MPa | 4.72 | MPa | 7.8 | MPa | 8.0 | MPa | 6.7 | MPa | 9.8 | MPa |
| shear | | | | | | | | | | | | | | | | |
| DT4-A1An lap | 2.1 | MPa | 4.2 | MPa | 3.8 | MPa | 1.5 | MPa | 4.7 | MPa | 4.3 | MPa | 4.4 | MPa | 3.4 | MPa |
| shear | | | | | | | | | | | | | | | | |
| PI-PI 180° peel | 17.7 | N/in | 20.5 | N/in | 19.8 | N/in | 9.1 | N/in | 33.6 | N/in | 27.5 | N/in | 35.5 | N/in | 32.9 | N/in |

| strength | | | | | | | | |
|---|---|---|---|---|---|---|---|---|
| Strength | 79.9% | 83.8% | 78.4% | substrate | 68.8% | 64.6% | 59.2% | 78.1% |
| attenuation rate | | | | detachment | | | | |
| after 7-day | | | | nearly | | | | |
| double 85 | | | | 100% | | | | |
| aging | | | | | | | | |

### Notes on the Test Items

Recyclable Component Content of Hot melt Adhesive: the net content of recyclable components in the adhesive formulation, specifically the weighted sum of recyclable component contents in each recyclable raw material, expressed as a mass percentage of the total formulation.

Viscosity Test: to test the viscosity value of the hot melt adhesive using a Brookfield DV2T viscometer with #28 rotor at 100° C.

Open Time: the hot melt adhesive in a molten state at 120° C. is applied on release paper to form a 200 μm-thick adhesive film, to test the tackiness of the adhesive film using kraft paper; if substrate breakage occurs when the bonded kraft paper is peeled off, the corresponding time falls within the open time; if the bonded kraft paper can be completely peeled off, it indicates that the adhesive film has lost effective tackiness, and this period is defined as the open time of the adhesive.

Cured State of Adhesive Line: a 1 mm-wide adhesive line is dispensed using a Nordson PJ-30 jet dispensing system, and the foaming condition of the adhesive line is observed after curing for 24 hours.

PC-PC Lap Shear Strength: PC refers to polycarbonate substrate, with a bonding area of 25 mm×12.5 mm×0.25 mm (length×width×thickness); after curing for 24 hours, the shear strength is measured using an electronic universal testing machine at a tensile speed of 10 mm/min.

DT4-AlAn Lap Shear Strength: DT4 refers to galvanized stainless steel, and AlAn refers to anodized aluminum, with a bonding area of 25 mm×12.5 mm×0.25 mm (length×width×thickness); after curing for 72 hours (compared with plastics, metals have better water vapor barrier properties, so the curing time of the adhesive in between needs to be longer, with an empirical value of 72 hours), the shear strength is measured using an electronic universal testing machine at a tensile speed of 10 mm/min.

PI-PI 180° Peel Strength: PI refers to polyimide substrate, with a bonding width of 25.04 mm (i.e., 1 in) and an adhesive coating thickness of 100 μm; after curing for 24 hours, the 180° peel strength is measured using an electronic universal testing machine at a tensile speed of 50 mm/min.

Strength Attenuation Rate After 7-Day Double 85 Aging: a PC-PC lap shear specimen is prepared and placed in an aging chamber at 85° C.-85% RH for 7 days to test its shear strength, and then its attenuation rate relative to the shear strength of normal PC-PC specimens is calculated.

### CONCLUSION

As can be seen from Examples 1-7, the amounts of recycled PET-based polyester polyol in the hot melt adhesive formulations are 50% or more, and the contents of recyclable components in the hot melt adhesive are above 20%. Analysis of the performance data shows that the bonding strengths of the hot melt adhesives to DT4-AlAn and the PI-PI 180° peel strength are all significantly higher than those of the commercial petroleum-based product EH9650, while their bonding strengths to PC (a common plastic substrate) are comparable to that of EH9650. The evaluation on the hydrothermal aging resistance shows that the strength attenuation rates of the hot melt adhesives after 7 days of double 85 aging are all lower than that of EH9650. Example 6 includes 15% silane coupling agent and has a relatively low R value; most of the active NCO groups in the adhesive react with the secondary amine groups in the silane coupling agent; its final curing mechanism includes minor curing of NCO groups with moisture and silane hydrolysis curing. The cured adhesive has a backbone rich in siloxane bonds, with excellent hydrolysis resistance and a strength attenuation rate of only 42.5% after double 85 aging.

As to balanced control between the hot melt adhesive viscosity and the post-curing foaming issue, extensive use of the recycled PET-based polyester polyol tends to increase the viscosity of the hot melt adhesive. In Examples 1-4, the viscosity of the hot melt adhesive is reduced by increasing the amount of isocyanate, and then the secondary amine-containing silane coupling agent is used to consume excess NCO groups introduced by isocyanates, thus confining the R value within the range of 2-5. The resulting hot melt adhesive exhibits moderate viscosity and no foaming after adhesive line curing. In Example 5, the amount of recycled PET-based polyester polyol added reaches 70%, while less isocyanate is added to minimize curing foaming caused by active NCO groups. The synthesized adhesive still meets application requirements but suffers from higher viscosity, shorter open time, and a decreasing trend in bonding strength to various substrates.

Comparative Examples 1-7 serve as control groups for Example 1. In Comparative Example 1, the content of recycled PET-based polyol is less than 50%, leading to lower PC-PC lap shear strength, lower DT4-AlAn lap shear strength, and lower PI-PI 180° peel strength compared with Examples 1-4.

In Comparative Example 2, no recyclable PLA-based polyol is added, and its open time is close to that of Example 1. A key characteristic of the polyurethane hot melt adhesive is that the polyol component primarily regulates the open time. The difference in polyol components between the two formulations lies in that Example 1 uses PLA-1, while Comparative Example 2 uses the petroleum-based liquid polyol Dynacoll 7250. This indicates that the synthesized recyclable PLA-based polyol, similar to liquid polyols, functions to adjust the open time of the hot melt adhesive. However, since Comparative Example 2 adopts petroleum-based liquid polyol, the recyclable component content of its hot melt adhesive is below 20%.

In Comparative Example 3, no recycled PET-based polyol is added, but extensive PLA-based polyol is used, resulting in significant extension of the hot melt adhesive's open time. As the formulation lacks PET-based polyol with aromatic ring structures, the hot melt adhesive shows poor bonding strength to metal substrates and polyimide substrates, so that its strength attenuation rate after 7 days of double 85 aging is higher than those of Examples 1-4.

In Comparative Examples 4-1 and 4-2, the R values are 1.95 and 1.87, respectively. The low isocyanate content leads to a corresponding reduction in free NCO groups in the final hot melt adhesive, which effectively controls post-curing foaming of the hot melt adhesive. Nevertheless, the viscosity of the hot melt adhesive reaches as high as 23,740 cp/100° C. and 19,650 cp/100° C., making it unsuitable for use as an electronic adhesive.

In Comparative Example 5, the R value is 5.16, and the prepared hot melt adhesive has a viscosity of 2,277 cp. The high content of free NCO groups in the adhesive causes severe foaming after curing. Foaming of the adhesive line directly impairs the bonding strength to substrates, resulting in extremely low PC-PC lap shear strength, DT4-AlAn lap shear strength, and PI-PI 180° peel strength. Furthermore, substrate detachment occurs after 7-day double 85 aging, leading to loss of adhesion.

In Comparative Example 6, the silane coupling agent includes two secondary amine groups, the addition of which triggers a violent reaction, resulting in increased adhesive viscosity and poor bonding performance as well as poor hydrothermal aging resistance.

In Comparative Example 7, the silane coupling agent includes primary amine groups, the addition of which induces gelation, and the prepared hot melt adhesive includes gel particles.

Comparative Example 8 is based on Example 5 with the amount of recycled PET-based polyester polyol increased to 73%. Performance data shows that its viscosity increases significantly, open time shortens, and bonding strength to various substrates decreases notably.

Finally, it is noted that the foregoing descriptions are merely exemplary embodiments of the present disclosure, which are not intended to limit the present disclosure. Although the present disclosure has been described in detail with reference to the aforementioned embodiments, those skilled in the art may still modify the technical solutions described in each of the aforementioned embodiments, or equivalently replace some of the technical features therein. Any modifications, equivalent substitutions, and improvements made within the spirit and principles of the present disclosure shall all fall within the scope of protection of the present disclosure.

1. A recyclable raw material-based polyurethane hot melt adhesive,
wherein raw materials for preparing the polyurethane hot melt adhesive include recycled PET-based polyester polyol; recyclable polylactic acid-based polyol, petroleum-based polyol and/or tackifying resin, secondary amine-containing silane coupling agent, and isocyanate;
wherein the recycled PET-based polyester polyol accounts for 50 wt % to 70 wt % of the total weight of the polyurethane hot melt adhesive;
molecular weight of the recycled PET-based polyester polyol is 2000-3500;
and an amount of the isocyanate added is controlled such that NCO/OH molar ratio R falls within the range of 2-5.

2. The polyurethane hot melt adhesive of claim 1, wherein a hydroxyl value of the recycled PET-based polyester polyol is 27 mgKOH/g-62 mgKOH/g, and a hydroxyl value of the recyclable polylactic acid-based polyol is 20 mgKOH/g-140 mgKOH/g.

3. The polyurethane hot melt adhesive of claim 1, wherein the petroleum-based polyol is one or more selected from the group consisting of crystalline polyester polyol, liquid polyester polyol and polyether polyol.

4. The polyurethane hot melt adhesive of claim 1, wherein the tackifying resin is one or more selected from the group consisting of acrylic resin, petroleum resin, and amorphous α-olefin copolymer.

5. The polyurethane hot melt adhesive of claim 1, wherein the isocyanate is an aromatic diisocyanate, comprising one or more selected from the group consisting of 4,4′-diphenylmethane diisocyanate, 2,4′-diphenylmethane diisocyanate, 2,2′-diphenylmethane diisocyanate, and carbodiimide-modified diphenylmethane diisocyanate.

6. The polyurethane hot melt adhesive of claim 1, wherein the secondary amine-containing silane coupling agent comprises only one single secondary amine group.

7. The polyurethane hot melt adhesive of claim 6, wherein the secondary amine-containing silane coupling agent comprises one or more selected from the group consisting of N-n-butyl-3-aminopropyltrimethoxysilane, bis-[3-(trimethoxysilyl) propyl]amine, bis-[3-(triethoxysilyl) propyl]amine, and N-ethyl-3-trimethoxysilyl-2-methylpropylamine.

8. The polyurethane hot melt adhesive of claim 1, wherein the polyurethane hot melt adhesive further comprises an additive, the additive being one or more of defoamer, fluorescent agent, water scavenger, antioxidant, and amine-based catalyst.

9. The polyurethane hot melt adhesive of claim 1, wherein components of the polyurethane hot melt adhesive comprise in parts by weight:
50-70 parts of the recycled PET-based polyester polyol;
10-30 parts of the recyclable polylactic acid-based polyol;
0-10 parts of the petroleum-based polyol;
0-10 parts of the tackifying resin;
2-15 parts of the secondary amine-containing silane coupling agent; and
10-30 parts of isocyanate;
wherein the parts by weight of the petroleum-based polyol and the tackifying resin are not both zero;
and total parts by weight of the polyurethane hot melt adhesive is 100 parts.

10. The polyurethane hot melt adhesive of claim 9, wherein the polyurethane hot melt adhesive further comprises 0.07-35 parts by weight of the additive.

11. A method of preparing a recyclable raw material-based polyurethane hot melt adhesive, comprising steps of:
1) preparing a molten polyol mixture using the following raw materials:
a) at least one type of recycled PET-based polyester polyol;
b) at least one type of recyclable polylactic acid-based polyol; and
c) petroleum-based polyol or tackifying resin;
2) adding isocyanate to react with the polyol mixture for polymerization to obtain a polyurethane prepolymer, wherein a molar ratio of NCO groups in the isocyanate to OH groups in the polyol mixture is 2-5; and
3) adding a secondary amino group-containing silane coupling agent, and grafting it onto a main chain of the polyurethane prepolymer, thereby obtaining the recyclable raw material-based polyurethane hot melt adhesive.

12. The method of preparing a polyurethane hot melt adhesive of claim 11, further comprising a step of: adding the additive between step 1) and step 2); or/and adding the additive between step 2) and step 3).
